(19) United States
(12) Patent Application Publication
(10) Pub. No.: US 2024/0086551 A1
(43) Pub. Date: Mar. 14, 2024

(54) DATA COMPRESSION METHOD AND APPARATUS, ELECTRONIC DEVICE, AND STORAGE MEDIUM

(71) Applicant: INSPUR ELECTRONIC INFORMATION INDUSTRY CO., LTD., Jinan, Shandong (CN)

(72) Inventor: Xu SUN, Jinan, Shandong (CN)

(21) Appl. No.: 18/270,237

(22) PCT Filed: Nov. 30, 2021
(86) PCT No.: PCT/CN2021/134429

§ 371 Date: Jun. 29, 2023

(30) Foreign Application Priority Data
Jul. 23, 2021 (CN) 202110837935.5

(51) Int. Cl. G06F 21/60; H03M 7/30

(52) U.S. Cl. CPC G06F 21/602; H03M 7/6011

(57) ABSTRACT

The present application discloses a data compression method and apparatus, an electronic device, and a computer-readable storage medium. The method includes: determining a compression function and each initial register value in present compression; and executing the compression function on the basis of each initial register value, and in the execution process, using a carry skip adder to perform the addition operation in the compression function to obtain the value of each register after the present compression is completed. In the data compression method provided by the present application, the use of the carry skip adder to perform the addition operation in the compression function improves calculation efficiency of the compression function, such that the critical path may be shortened so as to improve overall algorithm performance in the hardware implementation.

The present application claims the priority of the Chinese patent application filed on Jul. 23, 2021 before the China National Intellectual Property Administration with the application number of 202110837935.5 and the title of “DATA COMPRESSION METHOD AND APPARATUS, ELECTRONIC DEVICE, AND STORAGE MEDIUM”, which is incorporated herein in its entirety by reference.

### FIELD

The present application relates to the technical field of data processing, and more particularly relates to a data compression method and apparatus, an electronic device, and a computer-readable storage medium.

### BACKGROUND

With the development and wide application of the information technology and the computer technology, people's requirements for the credibility of information data become increasingly high. In high-speed cryptographic chips, the Cryptographic Hash Algorithm (abbreviation: SM3) has been increasingly used for digital signature and verification, generation and verification of message authentication codes, and generation of random numbers in commercial cryptographic applications.

As the Cryptographic Hash Algorithm independently developed and designed by China, the SM3 algorithm has an output message digest value length of 256 bit, a message grouping length of 512 bit, and sixty-four times of iterative compression. In hardware implementation of the algorithm, data usually need to be subject to the processes such as message grouping and padding, extension and generation of message words, and sixty-four function iterative compression, in which the function iterative compression process is complicated in calculation, and consumes most resources and time.

Therefore, how to improve the calculation efficiency of a compression function is a technical problem to be solved by those skilled in the art.

### SUMMARY

It is an object of the present application to provide a data compression method and apparatus, an electronic device, and a computer-readable storage medium, which improve the calculation efficiency of a compression function.

In order to achieve the above object, the present application provides a data compression method, including:
determining a compression function and each initial register value in present compression; and
executing the compression function on the basis of each initial register value, and in an execution process, using a carry skip adder to perform an addition operation in the compression function to obtain a value of each register after the present compression is completed.

In some embodiments, the compression function is an SM3 algorithm compression function, and the carry skip adder is a two-input one-output 32 bit carry skip adder.

In some embodiments, the 32 bit carry skip adder includes eight groups of cascaded 4 bit carry skip adders.

In some embodiments, each initial register value is a value of each register after previous compression is completed or an initial value of each register.

In some embodiments, the data compression method further includes:
acquiring data to be compressed, performing padding grouping and grouping extension on the data to be compressed according to a preset rule so as to calculate message words required by the compression function, and generating the initial value of each register.

In some embodiments, the using a carry skip adder to perform an addition operation in the compression function to obtain a value of each register after the present compression is completed, includes:
using the carry skip adder to perform the addition operation of a primary critical path in the compression function to obtain the value of the register corresponding to the primary critical path after the present compression is completed.

In some embodiments, the registers include a first register, a second register, a third register, a fourth register and a fifth register, and the register corresponding to the primary critical path is the second register;
the using the carry skip adder to perform the addition operation of a primary critical path in the compression function to obtain the value of the register corresponding to the primary critical path after the present compression is completed, includes:
using a first carry skip adder to calculate a sum of an initial value of the first register shifted left by twelve bits and an initial value of the second register to obtain a first summation result;
using a second carry skip adder to calculate a sum of a preset constant shifted left by a preset number of bits and the first summation result to obtain a second summation result;
performing Boolean function processing on the initial value of the second register, an initial value of the third register and an initial value of the fourth register to obtain a Boolean function processing result;
using a third carry skip adder to calculate a sum of the Boolean function processing result and an initial value of the fifth register to obtain a third summation result;
using a fourth carry skip adder to calculate a sum of the message words and the third summation result to obtain a fourth summation result;
using a fifth carry skip adder to calculate a sum of the second summation result shifted left by seven bits and the fourth summation result to obtain a fifth summation result; and
performing a permutation operation on the fifth summation result to obtain a value of the second register after the present compression is completed.

In order to achieve the above object, the present application provides a data compression apparatus, including:
a determination module configured to determine a compression function and each initial register value in present compression; and
an execution module configured to execute the compression function on the basis of each initial register value, and in an execution process, use a carry skip adder to perform an addition operation in the compression function to obtain a value of each register after the present compression is completed.

In order to achieve the above object, the present application provides an electronic device, including:
a memory configured to store a computer program; and
a processor configured to implement operations of the above data compression method when the computer program is executed.

In order to achieve the above object, the present application provides a computer-readable storage medium having a computer program stored thereon, where the computer program implements the operations of the above data compression method when being executed by a processor.

It can be known from the above solution that the data compression method provided by the present application includes: determining a compression function and each initial register value in present compression; and executing the compression function on the basis of each initial register value, and in an execution process, using a carry skip adder to perform an addition operation in the compression function to obtain a value of each register after the present compression is completed.

It can be seen therefrom that in the data compression method provided by the present application, the use of the carry skip adder (CSA) for performing the addition operation in the compression function improves calculation efficiency of the compression function, such that the critical path may be shortened so as to improve overall algorithm performance in the hardware implementation. The present application further discloses a data compression apparatus, an electronic device, and a computer-readable storage medium, which may also achieve the above technical effects.

It is to be understood that both the foregoing general description and the following detailed description are merely exemplary, and are not restrictive of the present application.

### BRIEF DESCRIPTION OF THE DRAWINGS

In order to more clearly illustrate the technical solutions in the examples of the present application or in the prior art, the accompanying drawings to be used in the description of the examples or the prior art will be briefly introduced below. Apparently, the accompanying drawings in the description below are only some examples of the present application. For those ordinarily skilled in the art, other accompanying drawings may also be obtained according to these accompanying drawings without involving any inventive effort. The accompanying drawings are used for providing a further understanding of the present disclosure, constitute a part of the specification, illustrate the present disclosure together with the specific embodiments below, and are not intended to limit the present disclosure. In the drawings:

FIG. 1 is a flow chart illustrating a data compression method according to an exemplary example;

FIG. 2 is a frame diagram illustrating an SM3 algorithm according to an exemplary example;

FIG. 3 is a schematic diagram illustrating a single compression function in the SM3 algorithm according to an exemplary example;

FIG. 4 is a schematic diagram illustrating a calculation process of a primary critical path according to an exemplary example;

FIG. 5 is a structure diagram illustrating a 32 bit carry skip adder according to an exemplary example;

FIG. 6 is a structure diagram illustrating a 4 bit carry skip adder according to an exemplary example;

FIG. 7 is a structure diagram illustrating a data compression apparatus according to an exemplary example; and

FIG. 8 is a structure diagram illustrating an electronic device according to an exemplary example.

### DETAILED DESCRIPTION

The technical solutions in the examples of the present application will be clearly and completely described below with reference to the accompanying drawings in the examples of the present application. Obviously, the described examples are some, but not all, examples of the present application. Based on the examples in the present application, all other examples obtained by those ordinarily skilled in the art without involving any inventive effort are within the protection scope of the present application. In addition, in examples of the present application, “first”, “second”, and the like are used for distinguishing similar objects, and not necessarily used for describing a particular sequence or chronological order.

An example of the present application discloses a data compression method, which improves calculation efficiency of a compression function.

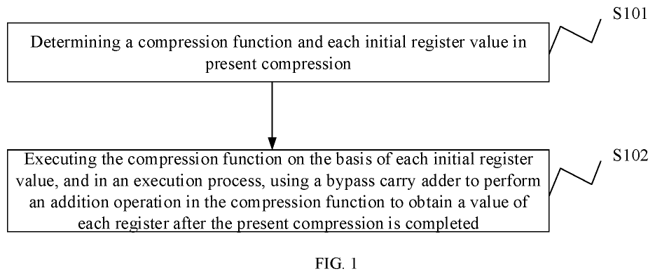

Referring to FIG. 1, a flow chart illustrating a data compression method according to an exemplary example, as shown in FIG. 1, includes:

S101: determining a compression function and each initial register value in present compression;

where in this example, the compression function may be embodied as an SM3 algorithm compression function. For the SM3 algorithm, a specific interface signal description is shown in Table 1:

TABLE 1

| | | | |
|---|---|---|---|
| | Input/ | | |
| singal | output | width | Description |

ClkRst

| | | | |
|---|---|---|---|
| clk | Input | [0] | Input clock |
| Rst | Input | [0] | Reset signal, active |
| | | | high |

Data input interface

| | | | |
|---|---|---|---|
| Data_in | Input | [width_data-l: 0] | Write data |
| Data_in_en | Input | [0:0] | Data valid flag |
| Data_in_strb | Input | [width_data/8-l: 0] | Write a byte line that |
| | | | the data is valid to |
| | | | indicate which 8 bits |
| | | | data is valid |
| Data_in_last | Input | [0:0] | Last valid number flag |

Data output interface

| | | | |
|---|---|---|---|
| Digest | output | [255:0] | Message digest value |
| | | | output bit |
| Digest_val | output | [0:0] | Message digest value |
| | | | valid flag bit |
| Fifo_read | output | [0:0] | Read external FIFO |
| | | | data control bit |

As a feasible embodiment, this example further includes: acquiring data to be compressed, performing padding grouping and grouping extension on the data to be compressed according to a preset rule so as to calculate message words required by the compression function, and generating the initial value of each register.

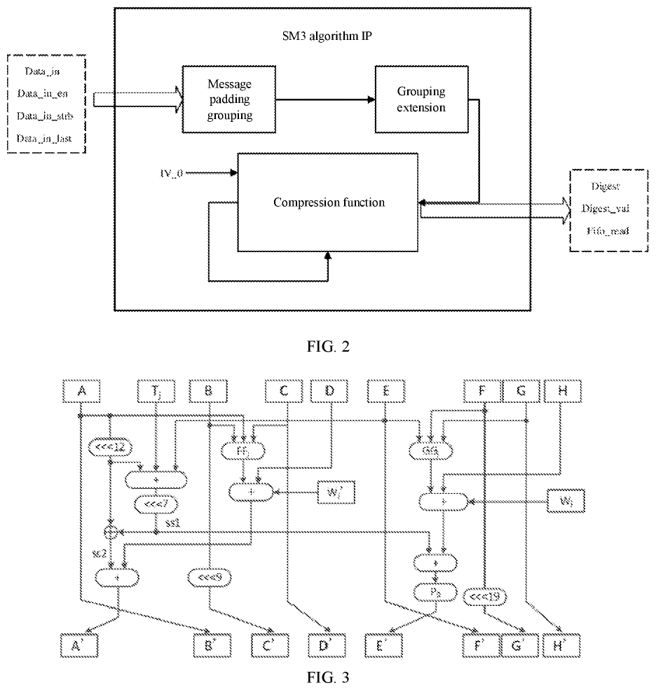

A frame diagram of the SM3 algorithm is shown in FIG. 2. In an implementation, firstly padding grouping is performed on plaintext data to be compressed, namely the input plaintext data to be compressed is padded according to a rule and divided into sets of 512 bit. After valid data for a port is received, the valid data is simultaneously cached into eight identical dual-port RAMs with a bit width of 32 bit and a depth of sixty-four, which are denoted as RAM_A, RAM_B, RAM_C, RAM_D, RAM_E, RAM_F, RAM_G and RAM_H. When a set of 512 bit data has been received, and a Data_in_last signal is still not received, it is indicated that the number of this data group is more than 512 bit, and padding processing is not required. When a set of 512 bit data has not been received, namely when there is Data_in_last, padding processing needs to be performed at this moment, firstly a bit “1” is added to the end of a message, and then “0” is added until 512 bit is reached.

Next, grouping extension is performed, namely the message words Wⱼ and W_{j′} required in the compression function are generated and fed into a specified location. As the message words need to be used for participating in calculation in subsequent iterative calculation of the compression function, in order to reduce operation time of iterative compression, the message words need to be generated in advance. In the padding grouping process, the 512 bit data has been written with 16 sets of data at a bit width of 32 bit and denoted as W₀-W₁₅, and the purpose of the grouping extension is to calculate and generate other one hundred and sixteen sets of data. A calculation formula for Wⱼ is as follows: Wⱼ=P1(Wⱼ−16⊕Wⱼ−9⊕(Wⱼ−3<<15))⊕(Wⱼ−13<<7)⊕Wⱼ−6, where each set of data is read out simultaneously by the RAMs, in some embodiments, Wⱼ−16 is read out by the RAM_A, Wⱼ−9 is read out by the RAM_B, Wⱼ−3 is read out by the RAM_C, Wⱼ−13 is read out by the RAM_D, and Wⱼ−6 is read out by the RAM_E. Corresponding cyclic shift and XOR operation are performed on the data read out according to the calculation formula of the algorithm, and then Wⱼ is calculated and written into the RAMs.

A calculation formula for is as follows: W_{j′}=Wⱼ⊕Wⱼ+4, where Wⱼ is read out by the RAM_F, Wⱼ₊₄ is read out by the RAM_G, bitwise XOR operation is performed according to the formula, and a calculation result is written back into the RAM_G.

In an iterative compression process of the SM3 algorithm, each initial register value includes a value of each register after previous compression is completed or an initial value of each register, a single compression function is as shown in FIG. 3, and the registers include A, B, C, D, E, F, G, and H.

S102: executing the compression function on the basis of each initial register value, and in an execution process, using a carry skip adder to perform an addition operation in the compression function to obtain a value of each register after the present compression is completed.

In this step, the compression function of the present compression is executed on the basis of each initial register value, and in the execution process, the carry skip adder is used to perform the addition operation. The idea of the carry skip adder is to accelerate the propagation of a carry chain, and in some cases, the carry reaching the ith bit does not need to wait for the carry at the (i−1)th bit, which improves the calculation efficiency.

In an example of the present application, the using a carry skip adder to perform an addition operation in the compression function to obtain a value of each register after the present compression is completed, includes: using the carry skip adder to perform the addition operation of a primary critical path in the compression function to obtain the value of the register corresponding to the primary critical path after the present compression is completed. It is understood that the use of the carry skip adder to perform the addition operation of the primary critical path is beneficial to the improvement of the calculation efficiency of the primary critical path. For the SM3 algorithm, a calculation path of the register E′ is the primary critical path.

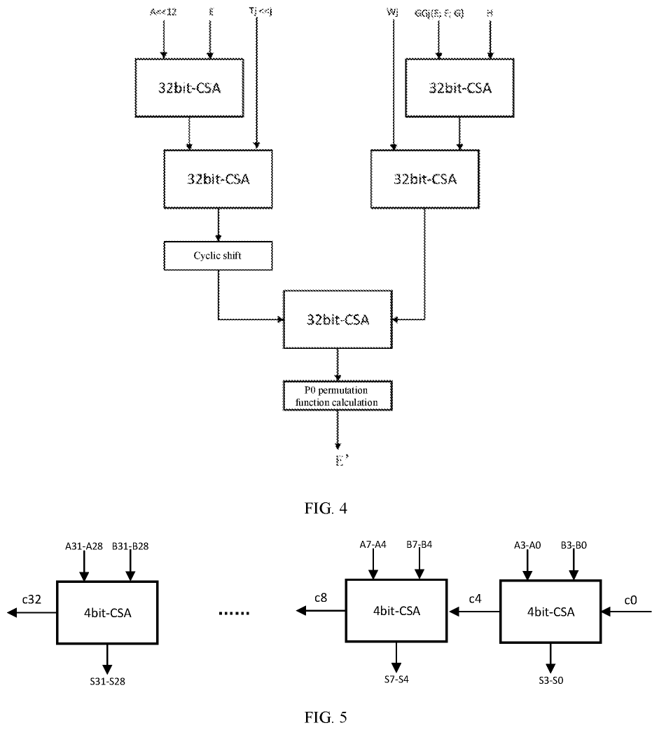

Further, the registers include a first register, a second register, a third register, a fourth register, and a fifth register, where the first register corresponds to A in FIG. 3, the second register corresponds to E in FIG. 3, the third register corresponds to F in FIG. 3, the fourth register corresponds to G in FIG. 3, the fifth register corresponds to H in FIG. 3, and the register corresponding to the primary critical path is the second register, namely, E′ in FIG. 3. A calculation process of the primary critical path is as shown in FIG. 4, and formulas are as follows:

SS1=((A<<12)+E+(Tj<<j))<<7

TT2=GGj(E;F;G)+H+SS1+Wⱼ

E′=P0(TT2)

That is to say, the using the carry skip adder to perform the addition operation of a primary critical path in the compression function to obtain the value of the register corresponding to the primary critical path after the present compression is completed, includes: using a first carry skip adder to calculate a sum of an initial value of the first register shifted left by twelve bits and an initial value of the second register to obtain a first summation result; using a second carry skip adder to calculate a sum of a preset constant shifted left by a preset number of bits and the first summation result to obtain a second summation result; performing Boolean function processing on the initial value of the second register, an initial value of the third register and an initial value of the fourth register to obtain a Boolean function processing result; using a third carry skip adder to calculate a sum of the Boolean function processing result and an initial value of the fifth register to obtain a third summation result; using a fourth carry skip adder to calculate a sum of the message words and the third summation result to obtain a fourth summation result; using a fifth carry skip adder to calculate a sum of the second summation result shifted left by seven bits and the fourth summation result to obtain a fifth summation result; and performing a permutation operation on the fifth summation result to obtain a value of the second register after the present compression is completed.

In the above formulas, GGj( ) is a Boolean function, Tj is the preset constant, j is the preset number of bits, P0( ) is a permutation function, and Wⱼ is the message word.

It can be known from FIG. 4 that the first carry skip adder, the second carry skip adder, the third carry skip adder, the fourth carry skip adder, and the fifth carry skip adder described above are all two-input one-output 32 bit carry skip adders. In the above calculation method, the calculation process of the primary critical path is decomposed into two groups of parallel calculations, namely, the first carry skip adder and the second carry skip adder are in one group, the third carry skip adder and the fourth carry skip adder are in the other group, and the two groups of parallel calculations improve the calculation efficiency of the primary critical path.

FIG. 5 is a structure diagram of a 32 bit carry skip adder, and it can be seen that in the 32 bit carry skip adder, the longest carry chain is c0->c1->c2-> . . . ->c32, that is to say, each bit full adder has a carry, and this path is also the longest critical path.

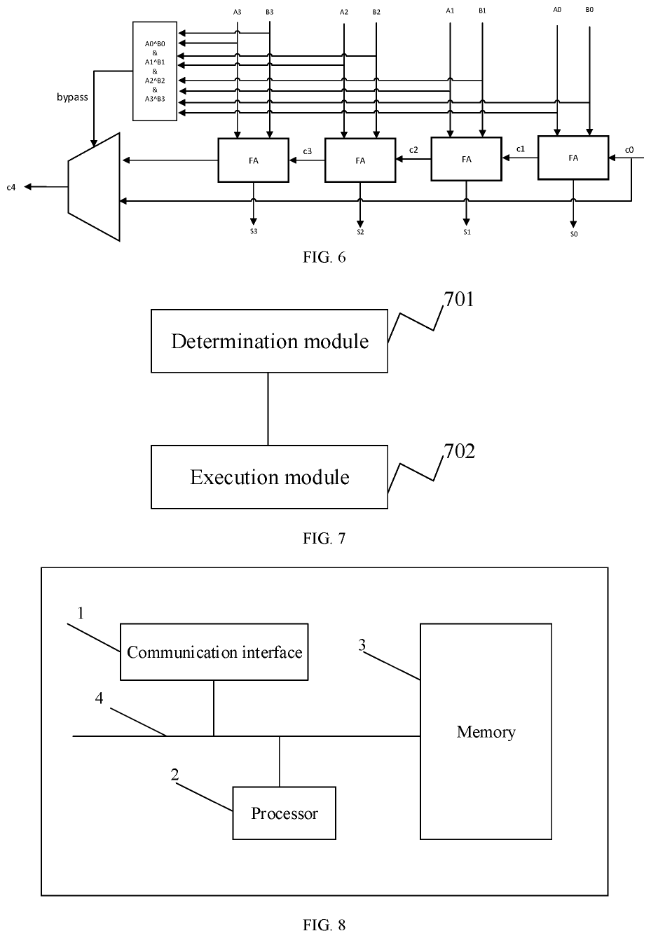

In the SM3 algorithm, all the addition operations involved are 32 bit data addition operations, so that 32 bit-CSA needs to be achieved, and may be generated by eight groups of 4 bit carry skip adders in cascade. By using this method, the design difficulty may be reduced, and the timing sequence may be optimized. FIG. 6 is a structure diagram of a 4 bit carry skip adder, and it can be seen that compared with a conventional full adder, the 4 bit carry skip adder shortens this longest path by adding a bypass logic consisting of a 2-select-1 data selector, a fourth-stage carry, a zeroth-stage carry and a carry bypass signal, where bypass=A0\hat{ }B0&A1\hat{ }B1&A2\hat{ }B2&A3\hat{ }B3. When the bypass signal is 1, c4=c0, and at this moment, the fourth-stage carry does not need to wait for a calculation result of the previous four-stage full adder, and the value of c0 is directly assigned to c4, thereby simplifying the calculation process, and optimizing the timing sequence.

It can be seen therefrom that in the data compression method provided by the examples of the present application, the use of the carry skip adder to perform the addition operation in the compression function improves calculation efficiency of the compression function, such that the critical path may be shortened so as to improve overall algorithm performance in the hardware implementation.

A data compression apparatus provided by the examples of the present application is described below, and reference may be made to the data compression apparatus described below and the data compression method described above.

Referring to FIG. 7, a structure diagram illustrating a data compression apparatus according to an exemplary example, as shown in FIG. 7, includes:
a determination module 701 configured to determine a compression function and each initial register value in present compression; and
an execution module 702 configured to execute the compression function on the basis of each initial register value, and in an execution process, using a carry skip adder to perform an addition operation in the compression function to obtain a value of each register after the present compression is completed.

It can be seen therefrom that in the data compression apparatus provided by the examples of the present application, the use of the carry skip adder to perform the addition operation in the compression function improves calculation efficiency of the compression function, such that the critical path may be shortened so as to improve overall algorithm performance in the hardware implementation.

On the basis of the above example, in an example of the present application, the compression function is an SM3 algorithm compression function, and the carry skip adder is a two-input one-output 32 bit carry skip adder.

On the basis of the above example, in an example of the present application, the 32 bit carry skip adder includes eight groups of cascaded 4 bit carry skip adders.

On the basis of the above example, in an example of the present application, each initial register value is a value of each register after previous compression is completed or an initial value of each register.

On the basis of the above example, in an example of the present application, the data compression apparatus further includes:
a generation module configured to acquire data to be compressed, perform padding grouping and grouping extension on the data to be compressed according to a preset rule so as to calculate message words required by the compression function, and generate the initial value of each register.

On the basis of the above example, in an example of the present application, the execution module 702 is a module configured to execute the compression function on the basis of each initial register value, and in an execution process, use a carry skip adder to the addition operation of a primary critical path in the compression function to obtain the value of the register corresponding to the primary critical path after the present compression is completed.

On the basis of the above example, in an example of the present application, the registers include a first register, a second register, a third register, a fourth register and a fifth register, and the register corresponding to the primary critical path is the second register;
the execution module 702 includes:
a first summation unit configured to use a first carry skip adder to calculate a sum of an initial value of the first register shifted left by twelve bits and an initial value of the second register to obtain a first summation result;
a second summation unit configured to use a second carry skip adder to calculate a sum of a preset constant shifted left by a preset number of bits and the first summation result to obtain a second summation result;
a processing unit configured to perform Boolean function processing on the initial value of the second register, an initial value of the third register and an initial value of the fourth register to obtain a Boolean function processing result;
a third summation unit configured to use a third carry skip adder to calculate a sum of the Boolean function processing result and an initial value of the fifth register to obtain a third summation result;
a fourth summation unit configured to use a fourth carry skip adder to calculate a sum of the message words and the third summation result to obtain a fourth summation result;
a fifth summation unit configured to use a fifth carry skip adder to calculate a sum of the second summation result shifted left by seven bits and the fourth summation result to obtain a fifth summation result; and
a permutation unit configured to perform a permutation operation on the fifth summation result to obtain a value of the second register after the present compression is completed.

With respect to the apparatus in the above example, the specific manner of execution and operation of each module in the apparatus has been described in detail in the examples of the method, and will not be described in detail herein.

Based on the hardware implementation of the above program module, and in order to implement the method of the examples of the present application, an example of the present application further provides an electronic device. FIG. 8 is a structure diagram illustrating an electronic device according to an exemplary example, and as shown in FIG. 8, the electronic device includes:
a communication interface 1 capable of performing information interaction with other devices, such as a network device;
a processor 2 which is connected with the communication interface 1 to achieve information interaction with other devices, and executes the data compression method provided by one or more technical solutions described above when being used to run a computer program, while the computer program is stored on a memory 3.

Certainly, in an actual application, various components in the electronic device are coupled together through a bus system 4. It is understood that the bus system 4 is used to achieve connection communication among these components. The bus system 4 includes a power bus, a control bus and a status signal bus, in addition to a data bus. However, for clarity of illustration, various buses are labeled as the bus system 4 in FIG. 8.

The memory 3 in the example of the present application is used to store various types of data to support the operation of the electronic device. Examples of such data include: any computer program for operating on the electronic device.

It is understood that the memory 3 may be either a volatile memory or a non-volatile memory, and may include both the volatile memory and the non-volatile memory, where the non-volatile memory may be a read-only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, a compact disc, or a compact disc read-only memory (CD-ROM); and the magnetic surface memory may be a magnetic disc memory or a magnetic tape memory. The volatile memory may be a random access memory (RAM), which serves as an external cache. By way of illustrative but not limiting description, many forms of RAMs are available, such as a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synclink dynamic random access memory (SLDRAM), and a direct rambus random access memory (DRRAM). The memory 2 described in the example of the present application is intended to include, without being limited to, these and any other suitable types of memories.

The method disclosed in the examples of the present application described above may be applied in or implemented by the processor 2. The processor 2 may be an integrated circuit chip having signal processing capability. In the implementation process, the operations of the above method may be performed by an integrated logic circuit of hardware or instructions in the form of software in the processor 2. The above processor 2 may be a general-purpose processor, a DSP, or other programmable logic devices, a discrete gate or transistor logic device, a discrete hardware component and the like. The processor 2 may implement or execute the various methods, steps, and logic block diagrams disclosed in the examples of the present application. The general-purpose processor may be a microprocessor, or any conventional processor and the like. The operations of the method disclosed in combination with the examples of the present application may be directly embodied as being executed and completed by a hardware decoding processor, or being executed and completed by the combination of hardware and software modules in a decoding processor. The software module may be located in a storage medium which is located in the memory 3, and the processor 2 reads a program in the memory 3 to perform the steps of the method described above in combination with hardware of the processor 2.

The processor 2, when executing the program, implements the corresponding flows in the various methods of the examples of the present application, and for the sake of brevity, it will not be described in detail herein.

In an exemplary example, the example of the present application further provides a storage medium, namely a computer storage medium, particularly a computer-readable storage medium, for example, including the memory 3 storing a computer program executable by the processor 2 to perform the steps of the above method. The computer-readable storage medium may be a memory such as an FRAM, an ROM, a PROM, an EPROM, an EEPROM, a flash memory, a magnetic surface memory, a compact disc, or a CD-ROM.

Those ordinarily skilled in the art will appreciate that all or some of the steps for implementing the examples of the above method may be performed by hardware associated with program instructions, and the above program may be stored in a computer-readable storage medium, and the program, when being executed, executes the steps including the examples of the above method; while the above storage medium includes: various media which may store program codes such as a mobile storage device, an ROM, an RAM, a diskette, or a compact disc and the like.

Alternatively, when the above integrated unit of the present application is implemented in the form of a software functional module and sold or used as an independent product, the integrated unit may also be stored in a computer-readable storage medium. Based on such an understanding, the technical solution of the examples of the present application, in essence or in part contributing to the prior art, may be embodied in the form of a software product, and the computer software product is stored in a storage medium including instructions for causing an electronic device (which may be a personal computer, a server, or a network device and the like) to perform all or some of the methods described in various examples of the present application, while the above storage medium includes: various media which may store program codes such as the mobile storage device, the ROM, the RAM, the diskette, or the compact disc and the like.

Although only the specific embodiments of the present application have been described above, the protection scope of the present application is not limited thereto, any person skilled in the art would readily conceive changes or substitutions within the technical scope disclosed by the present application, and all the changes or substitutions should fall within the protection scope of the present application. Therefore, the protection scope of the present application should be as set forth in the claims.

1. A data compression method, comprising:
determining a compression function and each initial register value in present compression; and
executing the compression function on the basis of each initial register value, and in an execution process, using a carry skip adder to perform an addition operation in the compression function to obtain a value of each register after the present compression is completed.

2. The data compression method according to claim 1, wherein the compression function is an SM3 algorithm compression function, and the carry skip adder is a two-input one-output 32 bit carry skip adder.

3. The data compression method according to claim 2, wherein the 32 bit carry skip adder comprises eight groups of cascaded 4 bit carry skip adders.

4. The data compression method according to claim 2, wherein each initial register value is a value of each register after previous compression is completed or an initial value of each register.

5. The data compression method according to claim 4, further comprising:
acquiring data to be compressed, performing padding grouping and grouping extension on the data to be compressed according to a preset rule so as to calculate message words required by the compression function, and generating the initial value of each register.

6. The data compression method according to claim 5, wherein the using a carry skip adder to perform an addition operation in the compression function to obtain a value of each register after the present compression is completed, comprises:
using the carry skip adder to perform the addition operation of a primary critical path in the compression function to obtain the value of the register corresponding to the primary critical path after the present compression is completed.

7. The data compression method according to claim 6, wherein the registers comprise a first register, a second register, a third register, a fourth register and a fifth register, and the register corresponding to the primary critical path is the second register;
the using the carry skip adder to perform the addition operation of a primary critical path in the compression function to obtain the value of the register corresponding to the primary critical path after the present compression is completed, comprises:
using a first carry skip adder to calculate a sum of an initial value of the first register shifted left by twelve bits and an initial value of the second register to obtain a first summation result;
using a second carry skip adder to calculate a sum of a preset constant shifted left by a preset number of bits and the first summation result to obtain a second summation result;
performing Boolean function processing on the initial value of the second register, an initial value of the third register and an initial value of the fourth register to obtain a Boolean function processing result;
using a third carry skip adder to calculate a sum of the Boolean function processing result and an initial value of the fifth register to obtain a third summation result;
using a fourth carry skip adder to calculate a sum of the message words and the third summation result to obtain a fourth summation result;
using a fifth carry skip adder to calculate a sum of the second summation result shifted left by seven bits and the fourth summation result to obtain a fifth summation result; and
performing a permutation operation on the fifth summation result to obtain a value of the second register after the present compression is completed.

8. (canceled)

9. An electronic device, comprising:
a memory configured to store a computer program; and
a processor configured to, when the computer program is executed, implementing operations comprising:
determining a compression function and each initial register value in present compression; and
executing the compression function on the basis of each initial register value, and in an execution process, using a carry skip adder to perform an addition operation in the compression function to obtain a value of each register after the present compression is completed.

10. A non-transitory computer-readable storage medium having a computer program stored thereon, wherein when being executed by a processor, the computer program implements operations comprising:
determining a compression function and each initial register value in present compression; and
executing the compression function on the basis of each initial register value, and in an execution process, using a carry skip adder to perform an addition operation in the compression function to obtain a value of each register after the present compression is completed.

11. The data compression method according to claim 1, wherein the compression function is a cryptographic hash algorithm (SM3) compression function.

12. The data compression method according to claim 5, wherein the performing padding grouping and grouping extension on the data to be compressed comprises:
padding input plaintext data to be compressed according to a rule, and dividing into sets of 512 bit; and
performing grouping extension, and generating message words Wⱼ and W_{j′} required in the compression function.

13. The data compression method according to claim 12, wherein a calculation formula for W_{j′} is: W_{j′}=Wⱼ ⊕Wⱼ+4.

14. The data compression method according to claim 7, wherein calculation formulas of the primary critical path are:
SS1=((A<<12)+E+(Tj<<j))<<7;
TT2=GGj(E;F;G)+H+SS1+Wi; and
E′=P0(TT2);
where A is the first register, E is the second register, F is the third register, G is the fourth register, H is the fifth register, GGj( ) is a Boolean function, Tj is the preset constant, j is the preset number of bits, P0( ) is a permutation function, Wⱼ is the message word, and E′ is the register corresponding to the primary critical path.

15. The data compression method according to claim 3, wherein the 4 bit carry skip adder shortens a longest path by adding a bypass logic; and
the bypass logic is consisting of a 2-select-1 data selector, a fourth-stage carry, a zeroth-stage carry and a carry bypass signal.

16. The data compression method according to claim 15, wherein when the bypass signal is 1, the fourth-stage carry does not need to wait for a calculation result of full adders of previous four stages, and the value of c0 is directly assigned to c4, where c0 is the zeroth-stage carry and c4 is the fourth-stage carry.

17. The electronic device according to claim 9, wherein the compression function is an SM3 algorithm compression function, and the carry skip adder is a two-input one-output 32 bit carry skip adder.

18. The electronic device according to claim 17, wherein the 32 bit carry skip adder comprises eight groups of cascaded 4 bit carry skip adders.

19. The electronic device according to claim 17, wherein each initial register value is a value of each register after previous compression is completed or an initial value of each register.

20. The electronic device according to claim 19, wherein the operations further comprises:
acquiring data to be compressed, performing padding grouping and grouping extension on the data to be compressed according to a preset rule so as to calculate message words required by the compression function, and generating the initial value of each register.

21. The electronic device according to claim 20, wherein the operation of using a carry skip adder to perform an addition operation in the compression function to obtain a value of each register after the present compression is completed, comprises:
using the carry skip adder to perform the addition operation of a primary critical path in the compression function to obtain the value of the register corresponding to the primary critical path after the present compression is completed.
